(19) United States
(12) Patent Application Publication
(10) Pub. No.: US 2018/0355776 A1
(43) Pub. Date: Dec. 13, 2018

(54) MULTISTAGE AMMONIA INJECTION SYSTEM FOR EXHAUST AFTERTREATMENT SYSTEM

(71) Applicant: General Electric Company, Schenectady, NY (US)

(72) Inventors: Bradly Aaron Kippel, Greenville, SC (US); Matthew Alan Johnsen, Simpsonville, SC (US); Rajesh Prabhakaran Saraswathi, Bangalore (IN)

(21) Appl. No.: 15/616,049

(22) Filed: Jun. 7, 2017

(51) Int. Cl. F01N 3/20; B01D 53/90; F01N 13/10; B01D 53/94

(52) U.S. Cl. CPC F01N 3/208; B01D 53/90; F01N 13/107; B01D 2251/2062; B01D 53/9409; B01D 53/9477; B01D 53/9431; F01N 3/2073

(57) ABSTRACT

A system is provided. The system includes an exhaust aftertreatment system configured to treat emissions from a gas turbine. The exhaust aftertreatment system includes multiple ammonia injection grids arranged in multiple stages. Each ammonia injection grid of the multiple ammonia injection grids is configured to inject ammonia into an exhaust flow from the gas turbine. Each ammonia injection grid of the multiple ammonia injection grids is individually tuned to operate with a specific load condition of the gas turbine.

### BACKGROUND

The subject matter disclosed herein relates to exhaust aftertreatment systems and, more specifically, to an ammonia injection system for exhaust aftertreatment systems.

During a typical combustion process within fossil fuel-fired industrial and electric utility equipment (e.g., furnace, boiler, gas turbine, etc.) combustion gases are produced. These combustion gases may include carbon monoxide (CO) and oxides of nitrogen (NO_{X}) among other combustion byproducts. Selective catalytic reduction (SCR) systems reduce the amount of NO_{X} and CO within the combustion gases. The ability to remove NO_{X} is dependent on numerous factors such as temperature (e.g., operating temperature) and homogeneity (e.g., uniform gas velocity, temperature, and ammonia (NH₃)/NO_{X} ratio distribution over a catalyst cross section). Proper mixing of ammonia with the exhaust gases is important to meet emission compliance requirements. Typically, ammonia injection systems of SCR systems include a single ammonia injection grid tuned (e.g., via manually tuned valves) for a specific load condition. However, the flow profile of the exhaust gas from the combustion system (e.g., gas turbine) is different at various load conditions. Thus, utilizing the ammonia injection system at a load condition different from what the single ammonia injection grid is tuned for may cause the SCR system to not achieve the desired homogeneity resulting in ammonia slip and/or the system to not comply with emission compliance requirements.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In accordance with a first embodiment, a system is provided. The system includes an exhaust aftertreatment system configured to treat emissions from a gas turbine. The exhaust aftertreatment system includes multiple ammonia injection grids arranged in multiple stages. Each ammonia injection grid of the multiple ammonia injection grids is configured to inject ammonia into an exhaust flow from the gas turbine. Each ammonia injection grid of the multiple ammonia injection grids is individually tuned to operate with a specific load condition of the gas turbine.

In accordance with a second embodiment, a system is provided. The system includes a gas turbine and a hot selective catalytic reduction (SCR) system fluidly coupled to the gas turbine and configured to treat emissions from the gas turbine. The hot SCR system includes a housing, a carbon monoxide (CO) oxidation catalyst disposed within the housing, a SCR catalyst disposed within the housing axially downstream of the CO oxidation catalyst, and multiple ammonia injection grids arranged in multiple stages and axially disposed between the CO oxidation catalyst and the SCR catalyst within the housing. Each ammonia injection grid of the multiple ammonia injection grids is configured to inject ammonia into an exhaust flow from the gas turbine. Each ammonia injection grid of the multiple ammonia injection grids is individually tuned to operate with a specific load condition of the gas turbine.

In accordance with a third embodiment, a system is provided. The system includes an exhaust aftertreatment system configured to treat emissions from a gas turbine. The exhaust aftertreatment system includes a first ammonia injection grid, a second ammonia injection grid, and a third ammonia injection grid. The first, second, and third ammonia injection grids are each configured to inject ammonia into an exhaust flow from the gas turbine. The first, second, and third ammonia injection grids are each individually tuned to operate with a different load condition of the gas turbine or different combinations of the first, second, and third ammonia injection grids are tuned to operate with different load conditions of the gas turbine.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an exhaust aftertreatment system (e.g., SCR system) coupled to a gas turbine; and

FIG. 2 is a flow chart of a method for utilizing a multistage ammonia injection system of the SCR system of FIG. 1.

### DETAILED DESCRIPTION

One or more specific embodiments of the present subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present disclosure relate to utilizing an ammonia injection system of an exhaust aftertreatment system that includes multiple stages. In particular, the ammonia injection system includes a plurality of ammonia injection grids arranged in parallel or series. Each ammonia injection grid and/or a combination of ammonia injection grids are tuned for a specific load condition (e.g., part load, base load, etc.) of the combustion system (e.g., gas turbine). As the load condition of the combustion system changes, a specific ammonia injection grid or combination of ammonia injection grids may be turned on or off (e.g., manually or automatically) to provide adequate mixing of the ammonia and homogeneity in mixing to reduce ammonia slip. Benefits of the disclosed embodiments include better mixing of ammonia for different load conditions, effective utilization of the catalyst, redundancy, improved overall reliability, and reduced ammonia slip.

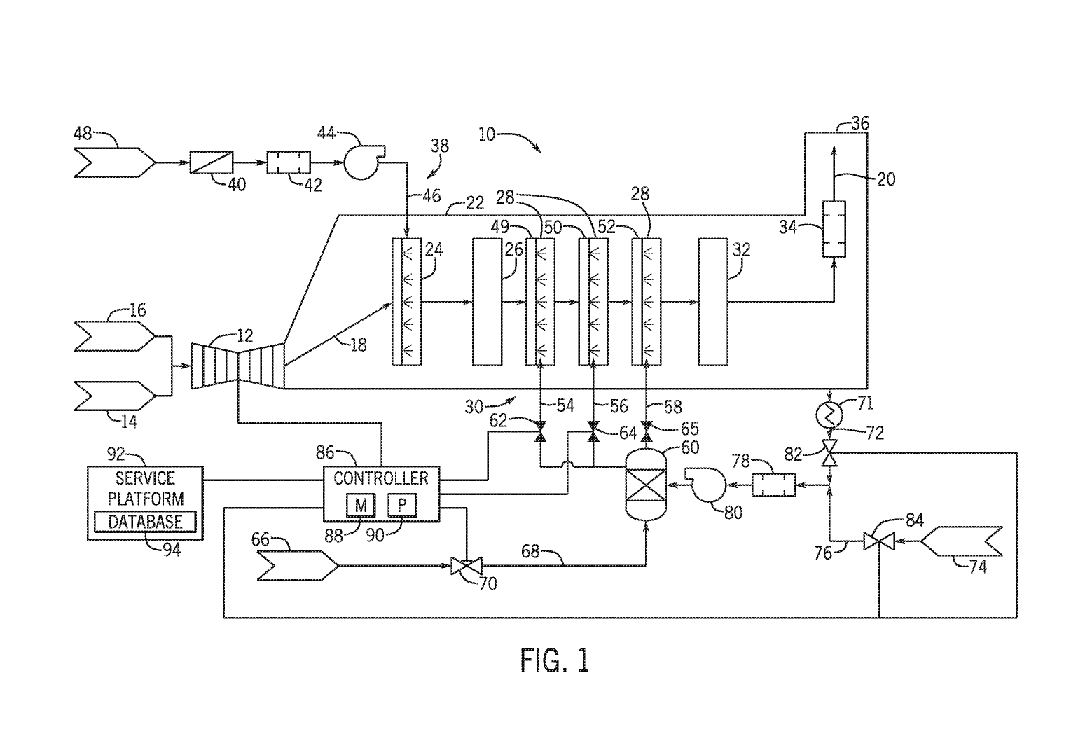

FIG. 1 is a schematic diagram of an exhaust aftertreatment system 10 (e.g., selective catalytic reduction (SCR) system) coupled to a gas turbine engine 12. In certain embodiments, the SCR system may include a hot SCR system (i.e., provides cooling or tempering air to reduce a temperature of exhaust exiting the gas turbine 12). In certain embodiments, the exhaust aftertreatment system 10 may be coupled to other fossil fuel-fired industrial and electric utility equipment (e.g., furnace, boiler, etc.). The gas turbine engine 12 may include a compressor, a combustor section, and a turbine. Air 14 (e.g., inlet air) and fuel 16 (e.g., liquid and/or gas fuel) are introduced into the gas turbine engine 12, where they are combined and combusted (e.g., to general a rotational force imparted on a shaft). An exhaust gas 18, which can be considered to be a flue gas, is produced from the combustion. The exhaust gas 18 includes undesirable combustion products such as carbon monoxide (CO) and oxides of nitrogen (NO_{X}) among others. The exhaust gas 18 is directed to the aftertreatment system 10 within which a reaction occurs to reduce the amount of the NOx, and/or other undesirable combustion products, present within a final gas 20 exiting the system 10. It is to be appreciated that the exhaust gas 18 is at an elevated temperature as compared to ambient atmospheric temperature. Moreover, such elevated temperature of the exhaust gas 18 may be at a highest level as the exhaust gas 18 proceeds from the gas turbine engine 12 to the aftertreatment system 10. For ease of discussion, such exhaust gas 18 is simply considered to be heated or hot.

The aftertreatment system 10 includes a housing 22. Disposed within the housing 22 along a flow path of the exhaust gas 18 is a tempering or cooling air grid 24, a CO oxidation catalyst 26, a plurality of ammonia injection grids 28 that form a part of an ammonia injection system 30, and an SCR catalyst 32. The aftertreatment system 12 also includes a silencer 34 and a stack 36. The tempering air grid 24 forms part of an air injection system 38 that injects air (or another fluid) into the exhaust gas 18 to temper or moderate the temperature of the exhaust gas 18 prior to the exhaust gas flowing to the catalytic beds of the CO oxidation catalyst 26 and the SCR catalyst 32. The air injection system 38 includes an air filter 40 (e.g., tempering air filter), an air silencer 42 (e.g., tempering air silencer), and a fan 44 (e.g., tempering air fan) disposed along an air supply flow path or line 46 coupled to the tempering air grid 24. Air 48 is filtered by the filter 40 and then flows through the silencer 42 to the fan 44 which provides the air 48 to the grid 24. The air 48 is injected into the exhaust gas 18 from the grid 24 (e.g., across a cross-section of the exhaust gas flow path) to temper the exhaust gas 18.

The CO oxidation catalyst 26 is disposed downstream (axially) of the tempering air grid 24. The CO oxidation catalyst 26 removes CO from the exhaust gas 18 upstream of the plurality of ammonia injection grids 28. The CO oxidation catalyst 26 may include a honeycomb-shaped substrate or another shape. The number of ammonia injection grids 28 may vary (e.g., 2, 3, 4, or more). The ammonia injection grids 28 are disposed within a multistage arrangement. As depicted, the ammonia injection grids 28 are arranged in series. In certain embodiments, the ammonia injection grids 28 may be arranged in parallel. The ammonia injection grids 28 may have a uniform or non-uniform arrangement. The specific arrangement of the ammonia injection grids 28 is dependent on the upstream flow profile. For example, the ammonia injection grids 28 may be concentrated in specific areas along the flow path of the exhaust gas. The ammonia injection grids 28 may be the same size or different sizes. Each ammonia injection grid 28 may include a plurality of injection tubes for injecting the ammonia. The injection tubes may be in a staggered and/or parallel arrangement. Each individual ammonia injection grid 28 may be individually tuned (e.g., during commission) to operate with a specific load condition of the gas turbine engine 12. For example, ammonia injection grid 49 may be tuned for a first load condition, ammonia injection grid 50 tuned for a second load condition, and ammonia injection grid 52 tuned for a third load condition, where the first, second, and third load conditions are different from each other (base, part load, etc.). In addition or alternatively, specific combinations of the ammonia injection grids 28 may be tuned (e.g., during commission) to operate with a specific load condition of the gas turbine engine 12. For example, ammonia injection grids 49, 50 may tuned for a first load condition, ammonia injection grids 50, 52 tuned for a second load condition, and ammonia injection grid 49, 52 tuned for a third load condition, where the first, second, and third load conditions are different from each other (base, part load, etc.).

Upon injection of the ammonia via one or more of the ammonia injection grids 28, the exhaust gas-ammonia mixture flows through the catalyst bed of the SCR catalyst 32 (e.g., disposed axially downstream of the grids 28), where the NOx reacts with the ammonia in the presence of oxygen to produce nitrogen and water. The SCR catalyst 32 is disposed downstream of the ammonia injection grids 28 and may include a honeycomb-shaped substrate or another shape. In certain embodiments, the SCR catalyst 32 may include an active phase of vanadium pentoxide on a carrier of titanium dioxide. The operating temperature for the catalytic process within the SCR catalyst 32 may range from 450° F. (232.2° C.) to 1100° F. (593.3° C.). In certain embodiments, normal operating temperature at full load may be approximately 850° F. (454.4° C.). Following the SCR catalyst 32, the exhaust gas 18 flows through the silencer 34 and then the stack 36, where the final gas 20 exits the system 10.

As mentioned above, the ammonia injection grids 28 form a part of the ammonia injection system 30. The ammonia injection system 30 includes respective ammonia flow pathways or lines 54, 56, 58 coupled to ammonia injection grids 49, 50, 52, respectively. In addition, ammonia flow pathways 54, 56, 58 are coupled to a vaporizer 60. Valves 62, 64, 65 are disposed along ammonia flow pathways 54, 56, 58, respectively, and are configured to be actuated (e.g., opened or closed) to regulate flow of ammonia to respective ammonia injection grids 49, 50, 52. The vaporizer 60 is coupled to an ammonia supply 66 (e.g., aqueous ammonia supply) via ammonia flow pathway 68. A valve 70 (e.g., control valve) is disposed along the pathway 68 and is configured to be actuated (e.g., open or closed) to regulate flow of ammonia to the vaporizer 60. The ammonia injection system 30 also includes a rapid start heater 71 disposed along pathway 72 and air supply 74 (e.g., ambient air supply) disposed along pathway 76 that together provide a portion of exhaust 18 (subsequent to treatment) and air to a mixer 78, which in turns provides an exhaust-air mixture to a fan 80 (e.g., dilution fan). The exhaust 18 heats the air provides to the mixer 78. The exhaust-air mixture is provided by the fan 80 to the vaporizer 60 to convert the aqueous ammonia to a gaseous ammonia for injection by the ammonia injection grids 28. Valves 82, 84 may be disposed along pathways 72, 76, respectively, to regulate the flow of exhaust 18 and air to the mixer 78.

A controller 86 is coupled to both the gas turbine engine 12 and the ammonia injection system 30. The controller 86 includes a memory 88 (e.g., a non-transitory computer-readable medium/memory circuitry) communicatively coupled to a processor 90. Each memory 88 stores one or more sets of instructions (e.g., processor-executable instructions) implemented to perform operations related to the components of the system 10 (e.g., gas turbine operation, ammonia injection system 30, etc.). More specifically, the memory 88 may include volatile memory, such as random access memory (RAM), and/or non-volatile memory, such as read-only memory (ROM), optical drives, hard disc drives, or solid-state drives. Additionally, the processor 90 may include one or more application specific integrated circuits (ASICs), one or more field programmable gate arrays (FPGAs), one or more general-purpose processors, or any combination thereof. Furthermore, the term processor is not limited to just those integrated circuits referred to in the art as processors, but broadly refers to computers, processors, microcontrollers, microcomputers, programmable logic controllers, application specific integrated circuits, and other programmable circuits. The controller 86 is coupled to and regulates actuation (e.g., opening or closing via actuators) of valves 62, 64, 65, 70, 82, 84 to regulate the flow of fluids within the ammonia injection system 30. In particular, the controller 86 controls opening and closing (e.g., via control signals to actuators) valves 82, 84 to regulate the mixing of the exhaust gas 18 and ambient air that is eventually provided to the vaporizer 60. The controller 86 also controls opening and closing valve 70 to regulate the aqueous ammonia provided to the vaporizer 60 and subsequent ammonia provide to ammonia flow pathways 54, 56, 58. Further, the controller 86 controls opening and closing valves 62, 64, 65 to regulate gaseous ammonia provided to ammonia flow pathways 54, 56, 58, respectively. In particular, the controller 86 may in response to changes in load conditions of the gas turbine engine 12 regulate which specific ammonia injection grid 28 or combination of ammonia injections grids 28 are utilized. In certain embodiments, the valves 62, 64, 65, 70 of the ammonia injection system 30 may be manually closed or opened in response to changes in the load conditions of the gas turbine engine 12 to ensure that a specific ammonia injection grid 28 or combination of ammonia injection grids 28 specifically tuned to the load condition are utilized.

The controller 86 is coupled to a service platform 92. The service platform 92 may be a software platform for collecting data from the system 10. In certain embodiments, the service platform 92 may be a cloud-based platform such as a service (PaaS). In certain embodiments, the service platform 92 may regulate ammonia injection system 30 similar to the controller 86 as described above. The service platform 92 is coupled to a database 94. The database 94 and/or the memory 88 may store data related to the system 10 (e.g., load conditions, which grid(s) 28 to utilize under specific load conditions of the gas turbine engine 12, etc.).

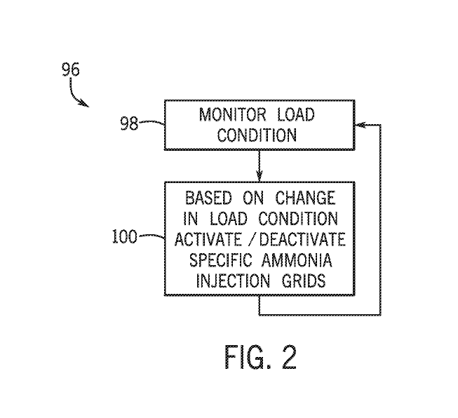

FIG. 2 is a flow chart of a method 96 for utilizing a multistage ammonia injection system 30 of the SCR system 10 of FIG. 1. In certain embodiments, all or some of the steps of the method 96 may be performed by the controller 86 and/or the service platform 92. The method 96 includes monitoring a load condition of the gas turbine engine 12 (block 98). In response to a change in the load condition of the gas turbine engine 12, one or more ammonia injection grids 28 may be activated (e.g., turned on by opening respective valves) and/or one or more ammonia injection grids 28 may be deactivated (e.g., turned off by closing respective valves (block 100). This enables the ammonia injection grid 28 or combination of ammonia injections grids 28 to be utilized that are specifically tuned for the load condition of the gas turbine engine 12. For example, a specific ammonia injection grid 28 or combination of ammonia injection grids 28 may be specifically tuned for a first load condition, while another ammonia injection grid 28 or combination of ammonia injection grids 28 may be specifically tuned for a second load condition different from the first load condition. The activation or deactivation of the ammonia injection grids 28 may be automatic (e.g., via the controller 86 and/or the service platform 92). In certain embodiments, the activation or deactivation of the ammonia injection grids 28 may be executed manually. Upon activation or deactivation of the ammonia injection grids 28, the method 96 includes continuing to monitor the load condition of the gas turbine engine 12 (block 98).

Technical effects of the disclosed embodiments include providing a multistage ammonia injection system where individual ammonia injection grids or combinations of ammonia injection grids are specifically tuned to different load conditions of a gas turbine engine. Benefits of the disclosed embodiments include better mixing of ammonia for different load conditions, effective utilization of the catalyst, redundancy, improved overall reliability, improved NOₓ reduction, and reduced ammonia slip.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
an exhaust aftertreatment system configured to treat emissions from a gas turbine, wherein the exhaust aftertreatment system comprises:
a plurality of ammonia injection grids arranged in multiple stages, wherein each ammonia injection grid of the plurality of ammonia injection grids is configured to inject ammonia into an exhaust flow from the gas turbine, and each ammonia injection grid of the plurality of ammonia injection grids is individually tuned to operate with a specific load condition of the gas turbine.

2. The system of claim 1, wherein a combination of ammonia injection grids of the plurality of ammonia injection grids is tuned to operate with the specific load condition of the gas turbine.

3. The system of claim 1, wherein the plurality of ammonia injection grids comprises a first ammonia injection grid individually tuned to operate with a first load condition of the gas turbine, a second ammonia injection grid individually tuned to operate with a second load condition of the gas turbine, and the first and second load conditions are different.

4. The system of claim 1, wherein the plurality of ammonia injection grids comprises a first ammonia injection grid, a second ammonia injection grid, and a third ammonia injection grid, the first and second ammonia injection grids are together tuned to operate with a first load condition of the gas turbine, the second and third ammonia injection grids are together tuned to operate with a second load condition of the gas turbine, and the first and second load conditions are different.

5. The system of claim 1, wherein the exhaust aftertreatment system comprises a carbon monoxide (CO) oxidation catalyst and a selective catalytic reduction (SCR) catalyst, and the plurality of ammonia injection grids are axially disposed between the CO oxidation catalyst and the SCR catalyst.

6. The system of claim 1, comprising a plurality of valves, wherein each respective valve of the plurality of valves is disposed along a respective ammonia flow path coupled to a respective ammonia injection grid of the plurality of ammonia injection grids, and each respective valve is configured to be actuated to control the flow of ammonia to the respective ammonia injection grid.

7. The system of claim 6, comprising a controller programmed to control ammonia injection into the exhaust flow by the plurality of ammonia injection grids via control of the plurality of valves based on the specific load condition of the gas turbine.

8. The system of claim 6, wherein the plurality of valves are configured to be controlled manually.

9. The system of claim 1, wherein the plurality of ammonia injection grids are arranged in series relative to the exhaust flow.

10. The system of claim 1, wherein the plurality of ammonia injection grids are arranged in parallel relative to the exhaust flow.

12. The system of claim 1, wherein the exhaust aftertreatment system comprises a hot selective catalytic reduction (SCR) system.

13. The system of claim 1, comprising the gas turbine fluidly coupled to the exhaust aftertreatment system.

14. A system, comprising:
a gas turbine;
a hot selective catalytic reduction (SCR) system fluidly coupled to the gas turbine and configured to treat emissions from the gas turbine, wherein the hot SCR system comprises:
a housing;
a carbon monoxide (CO) oxidation catalyst disposed within the housing;
a SCR catalyst disposed within the housing axially downstream of the CO oxidation catalyst;
a plurality of ammonia injection grids arranged in multiple stages and axially disposed between the CO oxidation catalyst and the SCR catalyst within the housing, wherein each ammonia injection grid of the plurality of ammonia injection grids is configured to inject ammonia into an exhaust flow from the gas turbine, and each ammonia injection grid of the plurality of ammonia injection grids is individually tuned to operate with a specific load condition of the gas turbine.

15. The system of claim 14, wherein a combination of ammonia injection grids of the plurality of ammonia injection grids is tuned to operate with the specific load condition of the gas turbine.

16. The system of claim 14, wherein the plurality of ammonia injection grids comprises a first ammonia injection grid individually tuned to operate with a first load condition of the gas turbine, a second ammonia injection grid individually tuned to operate with a second load condition of the gas turbine, and the first and second load conditions are different.

17. The system of claim 14, wherein the plurality of ammonia injection grids comprises a first ammonia injection grid, a second ammonia injection grid, and a third ammonia injection grid, the first and second ammonia injection grids are together tuned to operate with a first load condition of the gas turbine, the second and third ammonia injection grids are together tuned to operate with a second load condition of the gas turbine, and the first and second load conditions are different.

18. A system, comprising:
an exhaust aftertreatment system configured to treat emissions from a gas turbine, wherein the exhaust aftertreatment system comprises:
a first ammonia injection grid;
a second ammonia injection grid; and
a third ammonia injection grid, wherein the first, second, and third injection grids are each configured to inject ammonia into an exhaust flow from the gas turbine, and wherein first, second, and third injection grids are each individually tuned to operate with a different load condition of the gas turbine or different combinations of the first, second, and third ammonia injection grids are tuned to operate with different load conditions of the gas turbine.

19. The system of claim 18, wherein the first, second, and third ammonia injection grids are arranged in series or parallel relative to the exhaust flow.

20. The system of claim 18, wherein the exhaust aftertreatment system comprises a carbon monoxide (CO) oxidation catalyst and a selective catalytic reduction (SCR) catalyst, and the first, second, and third ammonia injection grids are axially disposed between the CO oxidation catalyst and the SCR catalyst.
